(19) United States
(12) Patent Application Publication
(10) Pub. No.: US 2015/0306814 A1
(43) Pub. Date: Oct. 29, 2015

(54) IMPRINT MOLD, AND IMPRINT METHOD

(71) Applicant: ASAHI GLASS COMPANY, LIMITED, Chiyoda-ku (JP)

(72) Inventors: Tomonori OGAWA, Tokyo (JP); Ryu TOMINAGA, Tokyo (JP)

(73) Assignee: ASAHI GLASS COMPANY, LIMITED, Chiyoda-ku (JP)

(21) Appl. No.: 14/696,634

(22) Filed: Apr. 27, 2015

(30) Foreign Application Priority Data
Apr. 28, 2014 (JP) 2014-092706

(51) Int. Cl. B29C 59/02; B29C 33/42

(52) U.S. Cl. CPC B29C 59/026; B29C 33/424; B29L 2031/34

(57) ABSTRACT

The present invention relates to an imprint mold containing a transfer surface and a concave-convex pattern and an imprint method using the imprint mold, in which the concave-convex pattern contains at least one groove formed on the transfer surface, the groove has a side wall part and a bottom wall part, and an angle between the side wall part and the transfer surface is larger than 90° and 96° or smaller.

### FIELD OF THE INVENTION

The present invention relates to an imprint mold and an imprint method.

### BACKGROUND ART OF THE INVENTION

Imprint method have attracted attention as an alternative technology of a photolithography method. The imprint method is a technology that a transfer material is sandwiched between a mold having a concave-convex pattern and a substrate, and the concave-convex pattern of the mold is transferred to the transfer material (e.g., see Patent Document 1). The imprint method can be applied to the production of not only a semiconductor element but also various products such as an antireflection sheet, a biochip and a magnetic recording medium.

Patent Document 1: JP-A-2009-48752

### SUMMARY OF THE INVENTION

Gas bubbles are sometimes caught between a mold and a substrate. Gas in the gas bubbles is dissolved in a transfer material, and then the gas bubbles are extinguished.

However, conventionally, extinction time of gas bubbles has been long and throughput has been therefore low.

Patent Document 1 above proposes that an angle between a side wall part of a concave portion of a mold and a bottom wall part of the concave portion is set to 40° or more and less than 90° in order to improve release property between the mold and a resist, but does not refer to extinction time of gas bubbles and also does not contain any description relating to an angle between a side wall part of the concave portion of the mold and a surface on which the concave portion is formed.

The present invention has been made in view of the above problems, and an object of the present invention is to provide an imprint mold that can improve throughput.

To solve the above problems, an aspect of the present invention is to provide an imprint mold containing a transfer surface and a concave-convex pattern, in which the concave-convex pattern contains at least one groove formed on the transfer surface, the groove has a side wall part and a bottom wall part, and an angle between the side wall part and the transfer surface is larger than 90° and 96° or smaller

The side wall part preferably has a surface roughness smaller than that of the bottom wall part.

Each of the side wall part and the bottom wall part has a surface roughness of preferably 0.1 nm or more and 10 nm or less.

The imprint mold according to the present invention preferably contains a plurality of the grooves formed on the transfer surface, and a pitch among the plurality of the grooves is preferably 100 nm or less.

The imprint mold according to the present invention is preferably made of an SiO₂ glass or a TiO₂—SiO₂ glass, more preferably made of the TiO₂—SiO₂ glass. The Ti0₂-Si0₂ glass preferably contains TiO₂ in an amount of from 5% by mass to 12% by mass.

The present invention also provides an imprint method containing: a transfer step of sandwiching a transfer material between a substrate and the imprint mold of the present invention, and transferring the concave-convex pattern to the transfer material.

According to the present invention, an imprint mold that can improve throughput and an imprint method using the imprint mold are provided.

### BRIEF DESCRIPTION OF THE DRAWINGS

FIG. 1 is a view illustrating an imprint mold according to one embodiment of the present invention.

FIG. 2 is a view illustrating an application step of an imprint method according to one embodiment of the present invention.

FIG. 3 is a view illustrating a transfer step of an imprint method according to one embodiment of the present invention.

FIG. 4 is a view illustrating the state when applying a transfer material according to one embodiment of the present invention.

FIG. 5 is a view illustrating wet spread of the transfer material of FIG. 4.

FIG. 6 is a view illustrating wet spread of the transfer material of FIG. 5.

FIG. 7 is a view illustrating the state of a transfer material contacting with a transfer surface of a mold according to one embodiment of the present invention.

FIG. 8 is a view illustrating wet spread of the transfer material of FIG. 7.

FIG. 9 is a view illustrating wet spread of the transfer material of FIG. 8.

FIG. 10 is a cross-sectional view illustrating one example of a model used in simulation analysis.

FIG. 11 is a graph showing one example of the relationship between the increase (T−T0)/T0 of time T obtained from simulation analysis result and a connection angle θ.

### DETAILED DESCRIPTION OF THE INVENTION

The mode for carrying out the present invention is described below in detail by reference to the drawings. In each drawing, the same or corresponding reference numerals and signs are applied to the same or corresponding constitutions, and the explanations thereof are omitted. In the present specification, the expression “form . . . to” indicating a numerical range means to a range including the recited numerical values.

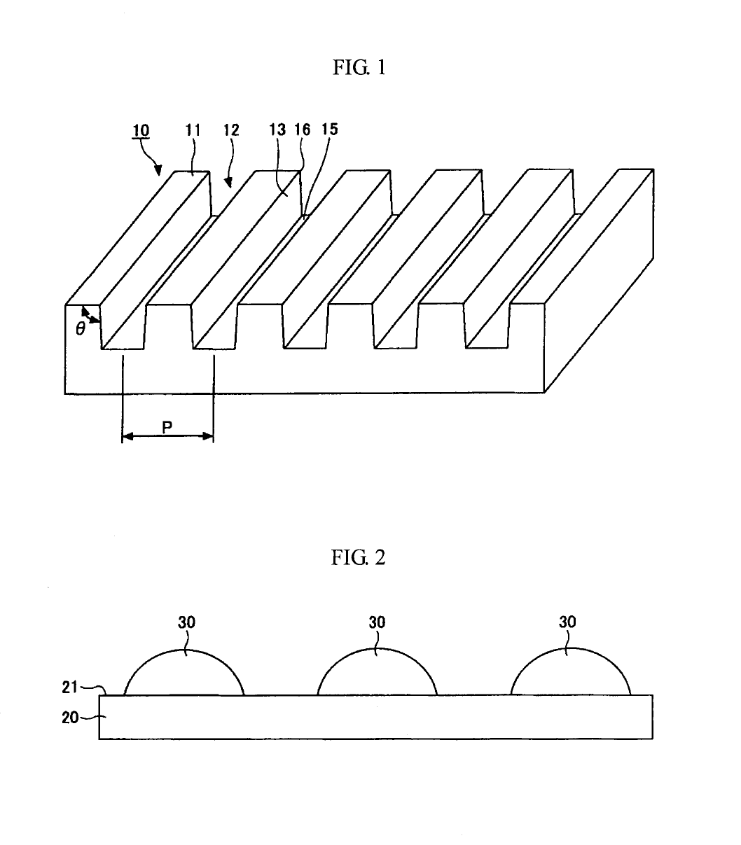

FIG. 1 is a view illustrating an imprint mold according to one embodiment of the present invention. Imprint method is described in detail hereinafter, but is a technology that a transfer material is sandwiched between a mold 10 having a concave-convex pattern and a substrate and the concave-convex pattern of the mold 10 is transferred to the transfer material.

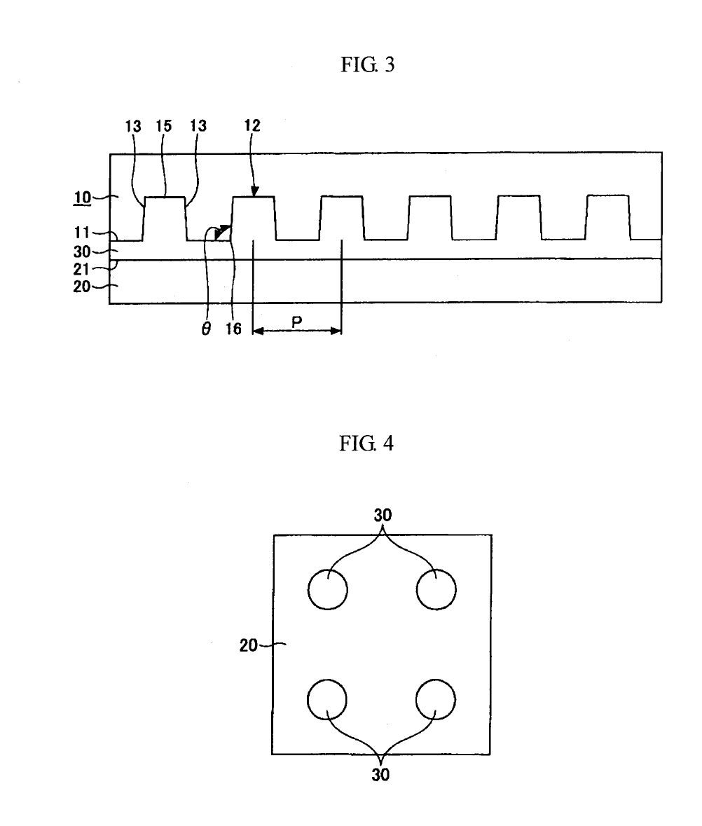

The mold 10 has a transfer surface 11 which is to be in contact with the transfer material, and a concave-convex pattern which contains at least one groove 12 formed on the transfer surface 11. The transfer surface 11 may be a flat surface. The groove 12 may be a linear groove and may have a straight-line shape. A plurality of grooves 12 may be formed on the transfer surface 11. Pitch P of the grooves 12 may be, for example, 100 nm or less, and preferably 50 nm or less. The grooves 12 in FIG. 1 have been formed with an equal pitch, but the grooves 12 may be formed with an unequal pitch. As illustrated in FIG. 3, the pitch P is a length between center lines of bottom wall surfaces 15 of adjacent two grooves 12.

The mold 10 may be made of an SiO₂ glass or a TiO₂—SiO₂ glass. The SiO₂ glass and the TiO₂—SiO₂ glass have a high ultraviolet transmittance as compared with a general soda lime glass. Furthermore, the SiO₂ glass and the TiO₂—SiO₂ glass have a small coefficient of linear expansion and a small dimensional change of a concave-convex pattern by temperature change, as compared with a general soda lime glass.

The TiO₂—SiO₂ glass has larger wet spread rate of a transfer material than that of the SiO₂ glass, and is therefore more preferred. The effect obtained by large wet spread rate of a transfer material is described hereinafter.

It is preferred that the TiO₂—SiO₂ glass contains TiO₂ in an amount of from 5 to 12% by mass. When the TiO₂ content is from 5 to 12% by mass, a coefficient of linear expansion in the vicinity of room temperature (e.g., 10 to 75° C.) is nearly zero, and dimensional change in the vicinity of room temperature does not substantially occur.

Concave-convex pattern of the mold 10 may be formed by transferring a concave-convex pattern of a master mold by an imprint method to a resist layer formed on a mold substrate, and subjecting the mold substrate to etching by using the resist layer as a mask. The etching may be either of dry etching or wet etching. The concave-convex pattern of a master mold may be formed by using an electron beam lithography system.

The mold 10 of the present embodiment can be obtained by using a master mold, but the mold may be a master mold itself, and is not particularly limited.

FIG. 2 is a view illustrating an application step of an imprint method according to one embodiment of the present invention. In the application step, a transfer material 30 is applied in a dot shape to a substrate 20.

As for the substrate 20, use can be made of a wafer for example. The wafer may have an element, a circuit, a terminal or the like formed thereon, and the transfer material 30 may be applied to, for example, an element formed on the wafer.

As for the transfer material 30, use can be made of a photocurable resin for example. For the photocurable resin, general resins used in an optical imprint method can be used.

FIG. 3 is a view illustrating a transfer step of an imprint method according to one embodiment of the present invention. In the transfer step, the transfer material 30 is sandwiched between the mold 10 and the substrate 20, and a concave-convex pattern of the mold 10 is transferred to the transfer material 30. The concave-convex pattern formed on the transfer material 30 is a pattern that the concave-convex pattern of the mold 10 has been nearly inversed.

The transfer material 30 is sandwiched in a liquid state between the mold 10 and the substrate 20, and solidified in the state. Solidification method is appropriately selected depending on the kind of the transfer material 30. In the case where the transfer material 30 is a photocurable resin, light (e.g., ultraviolet ray) is used.

The photocurable resin changes from a liquid to a solid by irradiation with light. The photocurable resin may be non-Newtonian fluid or a liquid having viscoelasticity. Light may be irradiated on the transfer material 30 through the mold 10. In the case where the substrate 20 has light transmission property, light may be irradiated on the transfer material 30 from a substrate 20 side. In this case, the mold 10 may not have light transmission property. Light may be irradiated on the transfer material 30 from both sides of the mold 10 and the substrate 20.

In the optical imprint method, molding is possible at room temperature. Further, strain due to the difference in coefficient of linear expansion between the mold 10 and the substrate 20 is difficult to occur, and transfer accuracy is good. Photocurable resin may be heated for the purpose of accelerating a curing reaction.

In the present embodiment, an optical imprint method is used, but a thermal imprint method may be used. In the case of a thermal imprint method, a thermoplastic resin or a thermosetting resin can be used as the transfer material 30. Thermoplastic resin is melted by heating and solidified by cooling. Thermosetting resin changes from a liquid to a solid by heating. Thermosetting resin may be non-Newtonian fluid or a liquid having viscoelasticity.

After solidification of the transfer material 30, the mold 10 is separated from the transfer material 30. Thus, a product containing a concave-convex layer obtained by solidifying the transfer material 30, and the substrate 20 can be obtained. The concave-convex pattern of the product is a pattern that the concave-convex pattern of the mold 10 has nearly been inversed, and the pattern is about the same as a concave-convex pattern of a master mold.

In the transfer step, gas bubbles get sometimes caught between the mold 10 and the substrate 20. Gas in the gas bubbles dissolves in the transfer material 30, and as a result, the gas bubbles are extinguished. Extinction time of gas bubbles depends on the kind of a gas in gas bubbles, an initial size of gas bubbles, and the like.

The kind of a gas in gas bubbles is preferably He gas. Atomic size of He gas is small as compared with the molecular size of N₂ gas that is a main component of air. Therefore, He gas is easy to dissolve in the transfer material 30 or the like as compared with N₂ gas, and as a result, extinction time of gas bubbles can be shortened. The transfer step may be conducted in He gas atmosphere such that a gas in gas bubbles is He gas.

Extinction time of gas bubbles is short as an initial size of gas bubbles is small.

The present inventors have found that anisotropy of wet spread rate of the transfer material 30 can be utilized in order to decrease an initial size of gas bubbles.

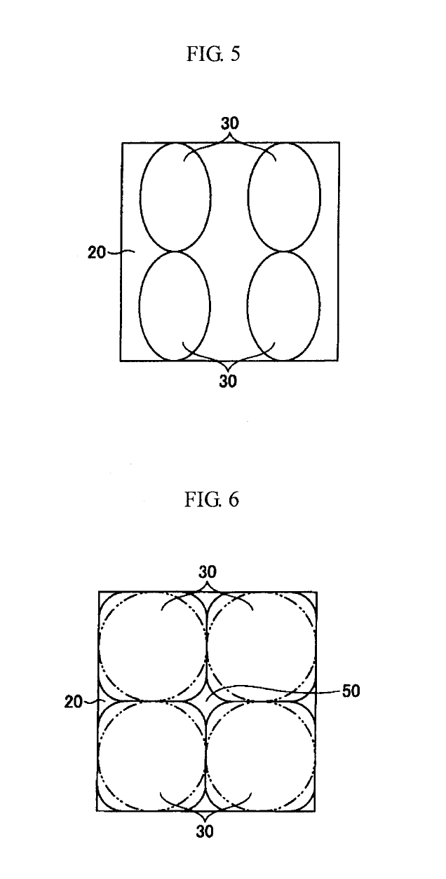

FIG. 4 is a view illustrating the state when applying the transfer material 30 to the substrate 20 according to one embodiment of the present invention. FIG. 5 is a view illustrating wet spread of the transfer material 30 of FIG. 4. FIG. 6 is a view illustrating wet spread of the transfer material 30 of FIG. 5. FIGS. 4 to 6 time-serially illustrate the states of the transfer material 30 in the case where wet spread rate shows an anisotropy (the case where wet spread rate in right and left directions in the drawings is smaller than that in up and down directions). In FIG. 6, a two-dot chain line indicates the state of a transfer material in the case where wet spread rate does not show anisotropy.

As illustrated in FIG. 4, the transfer material 30 is applied in a dot shape on the substrate 20 in the state of a liquid. Thereafter, droplets of the transfer material 30 are sandwiched between the substrate 20 and the mold 10, and are wet-spread. In the case where wet spread rate in right and left direction in the drawings is smaller than that in up and down directions as illustrated in FIGS. 4 to 6, after droplets adjacent in up and down directions have attached to each other, the droplets adjacent in right and left directions attach to each other, and as a result, gas bubbles 50 are confined among four droplets. On the other hand, in the case where wet spread rate does not show anisotropy as illustrated by two-dot chain line in FIG. 6, droplets spread outward in a radial direction while maintaining a circular shape, and four droplets simultaneously attach to each other. As a result, gas bubbles are confined among four droplets. As is apparent from FIG. 6, in the case where wet spread rate shows an anisotropy, an initial size of the gas bubbles 50 is small as compared with the case where wet spread rate does not show anisotropy.

Linear grooves 12 are formed on the transfer surface 11 of the mold 10 according to the present embodiment as illustrated in FIG. 1. Therefore, the transfer material 30 is easy to wet-spread along a longitudinal direction of the grooves 12. That is, wet spread rate V1 in a longitudinal direction of the grooves 12 is larger than wet spread rate V2 in a width direction of the grooves 12.

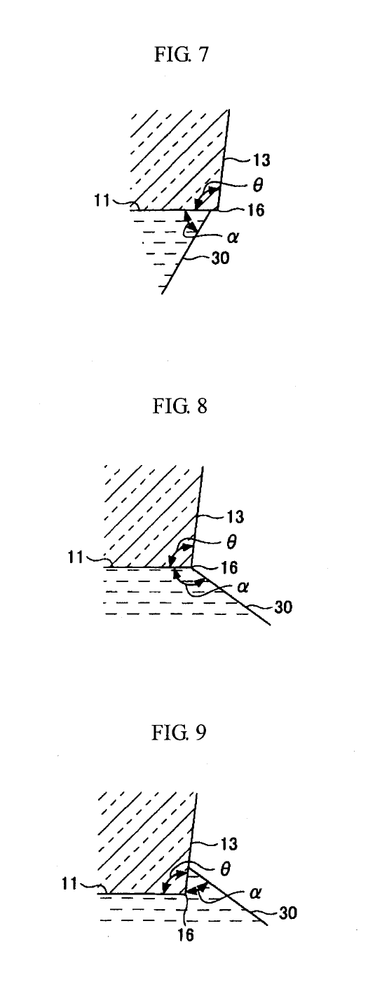

FIG. 7 is a view illustrating the state of a transfer material contacting with a transfer surface of a mold according to one embodiment of the present invention. FIG. 8 is a view illustrating wet spread of the transfer material of FIG. 7. FIG. 9 is a view illustrating wet spread of the transfer material of FIG. 8. FIGS. 7 to 9 time-serially illustrate the state of a transfer material.

When the transfer material 30 wet-spreads along the transfer surface 11, if the groove 12 is formed on the transfer surface 11, it takes time until that the transfer material 30 gets over a boundary 16 between a side wall part 13 of the groove 12 and the transfer surface 11. The reason for this is that in order that the transfer material 30 gets over the boundary 16, it is necessary that a contact angle α of the transfer material 30 becomes temporarily large as illustrated in FIGS. 7 to 9, and waiting time for this is generated. The wet spread rate V2 in a width direction of the groove 12 is small as the waiting time is longer.

The present inventors have found by simulation analysis and the like that in the case where an angle θ formed between the side wall part 13 of the groove 12 and the transfer surface 11 (hereinafter referred to as a “connection angle θ”) is 96° or smaller, anisotropy of wet spread rates V1 and V2 is remarkable. The connection angle θ is larger than 90° from the standpoint of release property between the mold 10 and the transfer material 30.

In the case where the side wall part 13 of the groove 12 is not a flat surface but is a curved surface, an angle formed between a tangent line of the side wall part 13 at a position equidistant from the bottom wall part 15 and the transfer surface 11 that are parallel to each other, and an extension surface of the transfer surface 11 is used as the connection angle θ.

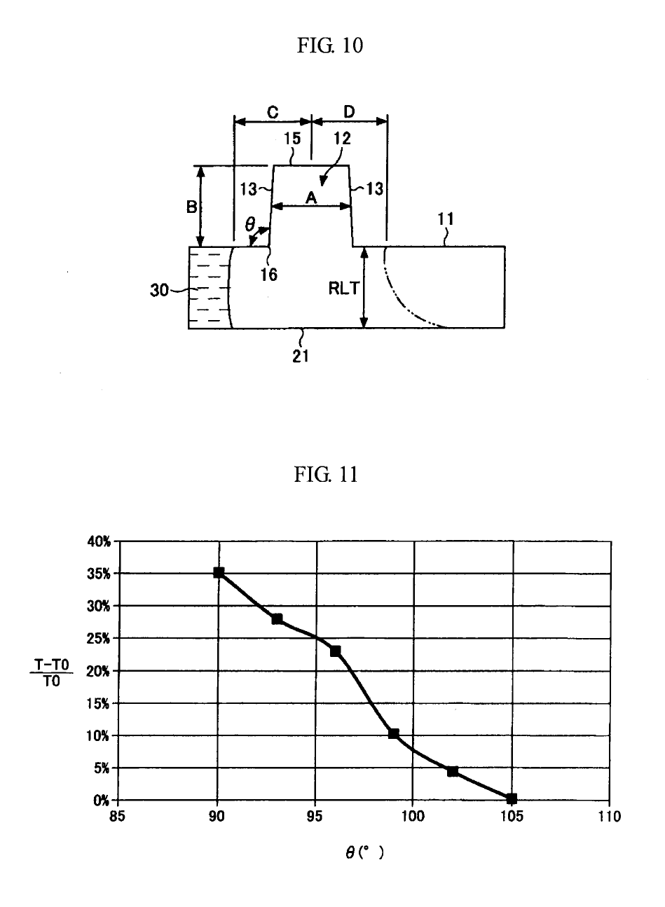

FIG. 10 is a cross-sectional view illustrating one example of a model used in the simulation analysis. In FIG. 10, a solid line indicates the state that a liquid level of a transfer material positions in a starting point, and a two-dot chain line indicates the state that the liquid level of the transfer material reaches in a goal point. The start point and goal point were set on the transfer surface 11.

In the simulation analysis, the relationship between time T until a liquid level of the transfer material 30 starts from the starting point, crosses the groove and reaches the goal point, and the connection angle θ was examined. The time T in the case where the connection angle θ is 105° was taken as T0. The increase (T−T0)/T0 of the time T was examined on the basis of T0. VOF method (Volume Of Fluid Method) was used as an analytical method, and ANSYS FLUENT (Ver. 14.5) manufactured by ANSYS, Inc., was used as an analytical software.

In the model illustrated in FIG. 10, a distance RLT between a surface 21 of the substrate 20 and the transfer surface 11 of the mold 10, that are parallel to each other was set to be 50 nm, a width A and a depth B of the groove 12 were both set to be 50 nm. Cross-sectional shape of the groove 12 was an isosceles trapezoidal shape. The width A of the groove 12 is a width at a position equidistant from the bottom wall part 15 of the groove 12 and the transfer surface 11, and is 50 nm regardless of the connection angle θ. Distance C between a center line of the groove 12 and the start point was 55 nm, and distance D between the center line of the groove 12 and the goal point was 50 nm.

As an initial condition, a region filled with the transfer material 30 was set to a left end portion in the drawing of a space formed between the surface 21 of the substrate 20 and the transfer surface 11 of the mold 10. As a boundary condition, Pressure Outlet conditions were set to right and left end portions in the drawing of the space, respectively. The transfer material 30 is supplied from a left end in the drawing of the space and a gas is discharged from a right end in the drawing of the space, while a liquid level of the transfer material 30 moves in a right direction in the drawing. No-slip condition was set to the surfaces with which the transfer material 30 contacts (the surface 21 of the substrate 20, the transfer surface 11 of the mold 10, and the side wall part 13 and bottom wall part 15 of the groove 12). Contact angles of the transfer material 30 to the surface 21 of substrate 20, the transfer material 30 to the transfer surface 11 of the mold 10, and the transfer material 30 to the side wall part 13 and the bottom wall part 15 of the groove 12 were set to 10°, 30°, and 30°, respectively.

FIG. 11 is a graph showing one example of the relationship between the increase (T−T0)/T0 of time T obtained from simulation analysis result, and a connection angle θ. In FIG. 11, a horizontal axis is the connection angle θ (°) and a vertical axis is the increase (T−T0)/T0 (%) of time T.

As is apparent from FIG. 11, the time T rapidly changes in the range that the connection angle θ is from 96° to 99°. When the connection angle θ is 96° or smaller, the time T is sufficiently large, the wet spread rate V2 in a width direction of the groove 12 is sufficiently small, and anisotropy of the wet spread rates V1 and V2 is sufficiently large. Therefore, an initial size of gas bubbles generated in the transfer step is sufficiently small, and throughput can be improved. The connection angle θ is preferably 93° or smaller.

The anisotropy of the wet spread rates V1 and V2 is remarkable in the case where the mold 10 is made of a TiO₂—SiO₂ glass, rather than the case of an SiO₂ glass. The TiO₂—SiO₂ glass is easy to be wet by transfer material 30, rather than the SiO₂ glass, and the wet spread rates V1 and V2 of the transfer material 30 is large. The anisotropy becomes remarkable as the wet spread rates V1 and V2 of the transfer material 30 become large. The reason for this is that since the transfer material 30 moves in a short period of time if the wet spread rate is large, influence of the waiting time for that the transfer material 30 gets over the boundary 16 is large.

The wet spread rates V1 and V2 also depend on surface roughness of surfaces with which the transfer material 30 contacts (the surface 21 of the substrate 20, the transfer surface 11 of the mold 10, and the side wall part 13 and bottom wall part 15 of the groove 12). As the surface roughness is large (that is, the surface is rough), the surface is easy to be wet by the transfer material 30, the wet spread rates V1 and V2 are large, and the anisotropy thereof is large.

Surface roughness Ra1 of the side wall part 13 of the groove 12 may be smaller than surface roughness Ra2 of the bottom wall part 15 of the groove 12. As the side wall part 13 of the groove 12 is smooth, the transfer material 30 is difficult to be wet, the time that the transfer material 30 creeps up on the side wall part 13 of the groove 12 is long, and the time that the transfer material 30 crosses the groove 12 is long. Therefore, the wet spread rate V2 in a width direction of the groove 12 can be further decreased.

The magnitude relation between the surface roughness Ra1 of the side wall part 13 and the surface roughness Ra2 of the bottom wall part 15 of the groove 12 can be adjusted by the conditions of etching that forms the groove part 12. For example, the groove part 12 can be formed by selecting the kind of etching gases and its mixing ratio, and etching conditions (specifically, process pressure, bias power, etc.) in suitable ranges. Specifically, the magnitude relation can be adjusted by introducing a rare gas, hydrogen gas, oxygen gas and the like in CF type gas under a pressure of from 0.1 to 10.0 Pa and applying a power of from 100 to 1,000 W to a plasma source, and a power of from 20 to 400 W to a substrate side.

The surface roughness Ra1 of the side wall part 13 of the groove 12 and the surface roughness Ra2 of the bottom wall part 15 of the groove 12 are, for example, 0.1 nm or more and 10 nm or less, preferably from 0.1 nm or more and 5 nm or less, and more preferably 0.1 nm or more and 3 nm or less, respectively. The surface roughness Ra1 and Ra2 are an arithmetic average roughness described in JIS B0601: 2013 (ISO 4287: 1997, Amd.1: 2009), and can be measured by AFM (Atomic Force Microscope). However, in the case where the relationship of Ra1<Ra2 is satisfied, Ra1 may be, for example, 0.1 nm or more and less than 10 nm, preferably 0.1 nm or more and less than 5 nm, and more preferably 0.1 nm or more and less than 3 nm, and Ra2 may be, for example, more than 0.1 nm and 10 nm or less, preferably more than 0.1 nm and 5 nm or less, and more preferably more than 0.1 nm and 3 nm or less.

The embodiments of an imprint mold and the like of the present invention are described above, but the present invention is not limited to the above embodiments, and various modifications and changes can be made within the scope and the spirit of the present invention described in the claims.

For example, the transfer material 30 of the above embodiment is applied in a dot shape to the substrate 20, but may be applied in a stripe shape. In this case, the transfer material 30 may be applied in an elongated shape in parallel to a longitudinal direction of the groove 12. Further, the transfer material 30 may be applied to the mold 10, not to the substrate 20.

The present application is based on a Japanese patent application 2014-092706 filed on Apr. 28, 2014, the contents of which are incorporated herein by reference.

### DESCRIPTION OF REFERENCE NUMERALS AND SIGNS

10 Mold
11 Transfer surface
12 Groove
13 Side wall part
15 Bottom wall part
20 Substrate
30 Transfer material

What is claimed is:

1. An imprint mold comprising a transfer surface and a concave-convex pattern, wherein
the concave-convex pattern comprises at least one groove formed on the transfer surface,
the groove has a side wall part and a bottom wall part, and
an angle between the side wall part and the transfer surface is larger than 90° and 96° or smaller.

2. The imprint mold according to claim 1, wherein the side wall part has a surface roughness smaller than that of the bottom wall part.

3. The imprint mold according to claim 1, wherein each of the side wall part and the bottom wall part has a surface roughness of 0.1 nm or more and 10 nm or less.

4. The imprint mold according to claim 1, comprising a plurality of the grooves formed on the transfer surface, wherein a pitch among the plurality of the grooves is 100 nm or less.

5. The imprint mold according to claim 1, made of an SiO₂ glass or a TiO₂—SiO₂ glass.

6. The imprint mold according to claim 5, made of the TiO₂—SiO₂ glass.

7. The imprint mold according to claim 6, wherein the TiO₂—SiO₂ glass comprises TiO₂ in an amount of from 5% by mass to 12% by mass.

8. An imprint method comprising:
a transfer step of sandwiching a transfer material between a substrate and the imprint mold described in claim 1, and transferring the concave-convex pattern to the transfer material.
